(19) United States
(12) Patent Application Publication
(10) Pub. No.: US 2010/0134586 A1
(43) Pub. Date: Jun. 3, 2010

(54) Exposure Head and Image Forming Apparatus

(75) Inventors: Ryuta KOIZUMI, Shiojiri-shi (JP); Yujiro NOMURA, Shiojiri-shi (JP); Ken IKUMA, Suwa-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/581,693

(22) Filed: Oct. 19, 2009

(30) Foreign Application Priority Data
Nov. 28, 2008 (JP) 2008-304813

(51) Int. Cl. B41J 2/435

(52) U.S. Cl. 347/224

(57) ABSTRACT

An exposure head and an image forming apparatus are provided. The exposure head includes: a lens array which has a first light transmissive substrate and a lens disposed on the first light transmissive substrate; a second light transmissive substrate; a light emitting element which is disposed on the second light transmissive substrate and emits light for transmitting the second light transmissive substrate to form an image through the lens; and a support member which supports a surface of the first light transmissive substrate on which the lens is disposed and a surface of the second light transmissive substrate on which the light emitting element is disposed.

### BACKGROUND

1. Technical Field

The present invention relates to an exposure head which images light from a light emitting element by a lens array and an image forming apparatus using the exposure head.

2. Related Art

Conventionally, a lens array in which a plurality of lenses is disposed on a surface of a light transmissive lens array substrate in which a glass substrate is used as a base material has been known (JP-A-2008-152040). In JP-A-2008-152040, an exposure head which images light from light emitting elements by the respective lenses of the lens array has been suggested. In particular, in the exposure head, the light emitting elements are disposed corresponding to the respective lenses. The light emitting elements are so-called bottom-emission type organic electroluminescence (EL) elements. That is, the light emitting elements are disposed on a back surface of the light transmissive light emitting element substrate in which a glass substrate is used as a base material, and light emitted from the light emitting elements transmits the light emitting element substrate and thereafter forms an image on an exposure target surface such as a surface of a latent image carrier by the lenses.

In order to achieve excellent exposure using the exposure head, the accuracy of an imaging position at which light from the light emitting element forms an image is important. However, according to the above-mentioned configuration, both the lens and the light emitting element are disposed on the light transmissive substrates (the lens array substrate and the light emitting element substrate). The light transmissive substrate is configured by the glass substrate as described above, and its thickness may not be uniform. In this case, the surface of the lens array substrate on which the lens is disposed and the surface of the light emitting element substrate on which the light emitting element is disposed are inclined to each other, and thus a distance between the lens and the light emitting element may vary. As a result, a magnification change and curvature of field occur, and the imaging position of light from the light emitting element changes, such that the possibility arises that exposure cannot be achieved with high accuracy. As a method of coping with the problem, a method of using light transmissive substrates with high thickness accuracy as the lens array substrate and the light emitting element substrate may be considered, but this method drastically increases the cost of the exposure head. A technique of defining the distance between the lens of the lens array and the light emitting element with high accuracy regardless of the thickness of the light transmissive substrate is needed.

### SUMMARY

An advantage of some aspects of the invention is that it provides a technique of achieving excellent exposure by defining the distance between the lens of the lens array and the light emitting element with high accuracy regardless of the thickness of the light transmissive substrate.

According to an aspect of the invention, there is provided an exposure head including: a lens array which has a first light transmissive substrate and a lens disposed on the first light transmissive substrate; a second light transmissive substrate; a light emitting element which is disposed on the second light transmissive substrate and emits light for transmitting the second light transmissive substrate to form an image through the lens; and a support member which supports a surface of the first light transmissive substrate on which the lens is disposed and a surface of the second light transmissive substrate on which the light emitting element is disposed.

According to an aspect of the invention, there is provided an image forming apparatus including: an exposure head which includes a lens array which has a first light transmissive substrate and a lens disposed on the first light transmissive substrate, a second light transmissive substrate, a light emitting element which is disposed on the second light transmissive substrate and emits light imaged by the lens, and a support member which supports a surface of the first light transmissive substrate on which the lens is disposed and a surface of the second light transmissive substrate on which the light emitting element is disposed; and a latent image carrier which is exposed to imaged light by the exposure head.

According to the invention (the exposure head and the image forming apparatus) configured as described above, the support member supports the surface of the first light transmissive substrate on which the lens is disposed and the surface of the second light transmissive substrate on which the light emitting element is disposed. Therefore, a distance between the surface of the first light transmissive substrate on which the lens is disposed and the surface of the second light transmissive substrate on which the light emitting element is disposed can be defined regardless of the thickness of the light transmissive substrate. As a result, a distance between the lens of the lens array and the light emitting element can be defined with high accuracy, whereby excellent exposure can be achieved.

The support member may support the surface of the first light transmissive substrate on which the lens is disposed and the surface of the second light transmissive substrate on which the light emitting element is disposed in parallel or nearly parallel. Therefore, the distance between the lens of the lens array and the light emitting element can be defined with high accuracy, whereby excellent exposure can be achieved.

The support member may include a first support portion which supports the surface of the first light transmissive substrate on which the lens is disposed, a second support portion which supports the surface of the second light transmissive substrate on which the light emitting element is disposed, and a connecting portion which connects the first support portion and the second support portion. Since the first support portion and the second support portion are connected by the connecting portion, a distance between the surface (the surface of the first light transmissive substrate on which the lens is disposed) supported by the first support portion and the surface (the surface of the second light transmissive substrate on which the light emitting element is disposed) supported by the second support portion can be accurately defined. As a result, the distance between the lens of the lens array and the light emitting element can be defined with high accuracy, whereby excellent exposure can be achieved.

The first support portion, the second support portion, and the connecting portion may be integrally formed. When the respective portions are separately configured and then combined, a surplus gap may be formed between the respective portions. On the other hand, when the respective portions are integrally configured, the surplus gap is inhibited from being formed, and the distance between the surface (the surface of the first light transmissive substrate on which the lens is disposed) supported by the first support portion and the surface (the surface of the second light transmissive substrate on which the light emitting element is disposed) supported by the second support portion can be more accurately defined.

A light shielding member which is disposed between the second light transmissive substrate and the lens array and has a light guide hole which allows light from the light emitting element to transmit may be disposed. A gap is preferably present between the lens array and the light shielding member in order to prevent a distance defined by the support member from being derailed due to contact between the light shielding member and the lens array.

The first light transmissive substrate and the second light transmissive substrate may be made of glass as a base material. Since a material of a relatively low price such as glass is used as a base material, the cost of the exposure head can be lower.

### BRIEF DESCRIPTION OF THE DRAWINGS

The invention will be described with reference to the accompanying drawings, wherein like numbers reference like elements.

FIG. 1 is a view illustrating an example of an image forming apparatus with a line head.

FIG. 2 is a view illustrating an electrical configuration of the image forming apparatus of FIG. 1.

FIG. 3 is a schematic perspective view illustrating the line head.

FIG. 4 is a plan view illustrating a configuration of a back surface of a head substrate.

FIG. 5 is a partial cross-sectional view of a line head taken along line V-V according to the present embodiment.

FIG. 6 is a partial cross-sectional view for explaining a problem to be resolved by the invention.

FIG. 7 is a partial cross-sectional view for explaining a problem to be resolved by the invention.

FIG. 8 is a partial cross-sectional view for explaining an effect of the invention.

FIG. 9 is a partial cross-sectional view illustrating a modified embodiment.

### DESCRIPTION OF EXEMPLARY EMBODIMENTS

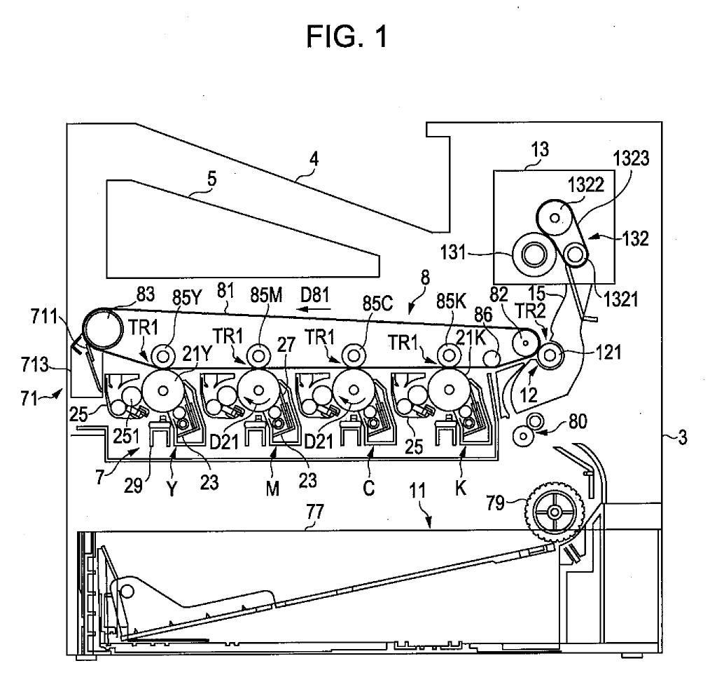

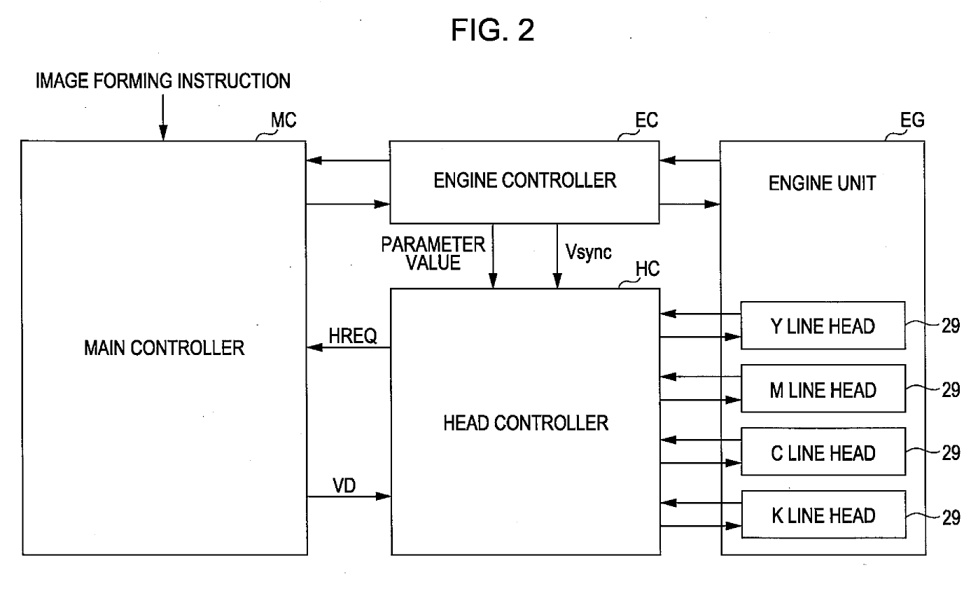

FIG. 1 is a view illustrating an example of an image forming apparatus with a line head. FIG. 2 is a view illustrating an electrical configuration of the image forming apparatus of FIG. 1. This apparatus is an image forming apparatus which can selectively execute a color mode in which toners of four colors of black (K), cyan (C), magenta (M), and yellow (Y) are superimposed to form a color image and a monochrome mode in which only a toner of black (K) is used to form a monochrome image. FIG. 1 is a view corresponding to the time of color mode execution. In the image forming apparatus, when an image forming instruction is output from an external apparatus such as a host computer to a main controller MC which includes a CPU and a memory, the main controller MC outputs a control signal to an engine controller EC and outputs video data VD corresponding to the image forming instruction to a head controller HC. At this time, whenever a horizontal request signal HREQ is received from the head controller HC, the main controller, MC outputs video data VD corresponding to one line in a main scanning direction MD to the head controller HC. The head controller HC controls the line heads 29 of respective colors based on the video data VD from the main controller MC, a vertical synchronous signal Vsync from the engine controller EC, and a parameter value. As a result, an engine unit EG executes a predetermined image forming operation to form an image corresponding to the image forming instruction on a sheet such as a copying paper, a transfer paper, a paper, and an OHP transparent sheet.

An electric component box 5 in which a power source circuit substrate, the main controller MC, the engine controller EC, and the head controller HC are embedded is disposed inside a housing body 3 of the image forming apparatus. An image forming unit 7, a transfer belt unit 8, and a paper feed unit 11 are also disposed inside the housing body 3. In FIG. 1, a secondary transfer unit 12, a fixing unit 13, and a sheet guide unit 15 are disposed on the right of the inside of the housing body 3. The paper feed unit 11 is configured to be attachable to an apparatus body 1. The paper feed unit 11 and the transfer belt unit 8 are configured to be removable for repair or replacement.

The image forming unit 7 includes four image forming stations Y (for yellow), M (for magenta), C (for cyan), and K (for black) for forming a plurality of different color images. Each of the image forming stations Y, M, C, and K includes a cylindrical photoreceptor drum 21 having a surface of a predetermined length in the main scanning direction MD. Each of the image forming stations Y, M, C, and K forms a corresponding color toner image on the surface of the photoreceptor drum 21. The photoreceptor drum 21 is disposed so that its axis direction is to be parallel or nearly parallel with the main scanning direction MD. Each photoreceptor drum 21 is connected to a dedicated driving motor to be rotatably driven at a predetermined speed in a direction of arrow D21 in FIG. 1. Therefore, a surface of the photoreceptor drum 21 is transported in a sub scanning direction SD which is perpendicular or nearly perpendicular to the main scanning direction MD. A charging unit 23, a line head 29, a developing unit 25, and a photoreceptor cleaner 27 are disposed around the photoreceptor drum 21 along a rotation direction. A charging operation, a latent image forming operation, and a toner developing operation are executed by the functional units. Therefore, when the color mode is executed, toner images formed by all of the image forming stations Y, M, C, and K are superimposed by a transfer head 81 of the transfer belt unit 8 to form a color image, while when the monochrome mode is executed, only a toner image formed by the image forming station K is used to form a monochrome image. In FIG. 1, since the respective image forming stations of the image forming unit 7 have the same configuration as each other, for convenience of illustration, reference numerals are conferred on only some of the image forming stations, and reference numerals for other image forming stations are omitted.

The charging unit 23 includes a charging roller having a surface made of elastic rubber. The charging roller is configured to come into contact with the surface of the photoreceptor drum 21 at a charging position and to be driven-rotated, and is driven-rotated at a circumferential speed in a driven direction with respect to the photoreceptor drum 21 according to the rotation operation of the photoreceptor drum 21. The charging roller is connected to a charging bias generating unit (not illustrated), and is supplied with charging bias from the charging bias generating unit and charges the surface of the photoreceptor drum 21 at the charging position at which the charging unit 23 and the photoreceptor drum 21 come into contact with each other.

The line head 29 is disposed to be separated from the photoreceptor drum 21. A longitudinal direction of the line head 29 is parallel or nearly parallel to the main scanning direction MD, and a width direction of the line head 29 is parallel or nearly parallel to the sub scanning direction SD. The line head 29 includes a plurality of light emitting elements which are lined up and disposed in the longitudinal direction. The light emitting elements emit light in response to video data VD from the head controller HC. Light from the light emitting elements is irradiated to the surface of the charged photoreceptor drum 21, and thus an electrostatic latent image is formed on the surface of the photoreceptor drum 21.

The developing unit 25 includes a developing roller 251 which carries a toner on its surface. Due to developing bias applied from a developing bias generating unit (not illustrated) which is electrically connected to the developing roller 251, at a developing position at which the developing roller 251 and the photoreceptor drum 21 come into contact with each other, a charging toner moves from the developing roller 251 to the photoreceptor drum 21, and so the electrostatic latent image formed by the line head 29 becomes obvious.

The toner image which becomes obvious at the developing position is transported in the rotation direction D21 of the photoreceptor drum 21 and then primarily transferred to the transfer belt 81 at a primary transfer position TR1 at which the transfer belt 81 and each photoreceptor drum 21 come into contact with each other.

In this embodiment, the photoreceptor cleaner 27 is disposed to come into contact with the surface of the photoreceptor drum 21 at a downstream side of the primary transfer position TR1 of the rotation direction D21 of the photoreceptor drum 21 and an upstream side of the charging unit 23. The photoreceptor cleaner 27 comes into contact with the surface of the photoreceptor drum 21 to remove a toner remaining on the surface of the photoreceptor drum 21 after primary transfer.

The transfer belt unit 8 includes a driving roller 82, a driven roller 83 (a blade facing roller) disposed at a left side of the driving roller 82 in FIG. 1, and the transfer belt 81 which is suspended between the rollers and rotatably driven in a direction (a transport direction) of arrow D81. The transfer belt unit 8 further includes four primary transfer rollers 85Y, 85M, 85C, and 85K which are disposed at an inner side of the transfer belt 81 to face the photoreceptor drums 21 of the image forming stations Y, M, C, and K in a one-to-one correspondence relationship when a photoreceptor cartridge is mounted. The primary transfer rollers 85 are electrically connected with a primary transfer bias generating unit (not illustrated), respectively. When the color mode is executed, as illustrated in FIG. 1, all of the primary transfer rollers 85Y, 85M, 85C, and 85K are positioned to the image forming stations Y, M, C, and K sides, and so the transfer belt 81 is pushed to come into contact with the photoreceptor drums 21 of the image forming stations Y, M, C, and K, so that the primary transfer positions TR1 are formed between the respective photoreceptor drums 21 and the transfer belt 81. Primary transfer bias is applied from the primary transfer bias generating unit to the primary transfer rollers 85 at appropriate timing, and so toner images formed on the surfaces of the respective photoreceptor drums 21 are transferred onto the surface of the transfer belt 81 at the corresponding respective primary transfer positions TR1 to thereby form a color image.

When the monochrome mode is executed, the primary transfer rollers 85Y, 85M, and 85C among the four primary transfer rollers 85 are separated from the respective image forming stations Y, M, and C, and only the monochrome primary transfer roller 85K comes into contact with the image forming station K. Therefore, only the monochrome image forming station K comes into contact with the transfer belt 81. As a result, the primary transfer position TR1 is formed only between the monochrome primary transfer roller 85K and the image forming station K. Primary transfer bias is applied from the primary transfer bias generating unit to the monochrome primary transfer roller 85K at appropriate timing, and so a toner image formed on the surface of the photoreceptor drum 21 is transferred onto the surface of the transfer belt 81 at the primary transfer position TR1 to thereby form a monochrome image.

The transfer belt unit 8 further includes a downstream guide roller 86 which is disposed at a downstream side of the monochrome primary transfer roller 85K and at an upstream side of the driving roller 82. The downstream guide roller 86 is configured to come into contact with the transfer belt 81 on a common inscribed line of the primary transfer roller 85K and the photoreceptor drum 21 at the primary transfer position TR1 formed when the monochrome primary transfer roller 85K comes into contact with the photoreceptor drum 21 of the image forming station K.

The driving roller 82 rotatably drives the transfer belt 81 in a direction of arrow D81 and functions as a back-up roller of a secondary transfer roller 121. A rubber layer in which a thickness is about 3 mm and a volume resistivity is equal to or less than 1,000 kΩ/cm is formed on a peripheral surface of the driving roller 82. The driving roller 82 is grounded through a shaft made of metal and functions as a conductive path of secondary transfer bias supplied from a secondary transfer bias generating unit which is not illustrated through the secondary transfer roller 121. The rubber layer with high friction and shock absorption is disposed on the driving roller 82 as described above, and thus, when a sheet enters a contact portion (a secondary transfer position TR2) between the driving roller 82 and the secondary transfer roller 121, a shock is hardly transmitted to the transfer belt 81, preventing the image quality from deteriorating.

The paper feed unit 11 has a paper feed section which includes a paper feed cassette 77 in which sheets are stacked and maintained and a pick-up roller 79 which feeds sheets from the paper feed cassette 77 one by one. The sheet fed from the paper feed section by the pick-up roller 79 is fed to the secondary transfer position TR2 along a sheet guide member 15 at feed timing adjusted by a pair of resist rollers 80.

The secondary transfer roller 121 is disposed to be freely separated from or come into contact with the transfer belt 81 and is driven to be separated from or come into contact with by a secondary transfer roller driving mechanism (not illustrated). A fixing unit 13 includes a rotatable heating roller 131 having a heating element such as a halogen heater and a pressure unit 132 which pressures and enforces the heating roller 131. A sheet on which an image is secondary-transferred is guided to a nip portion formed by the heating roller 131 and a pressure belt 1323 of the pressure unit 132 through the sheet guide member 15, and an image is thermally fixed in the nip portion at a predetermined temperature. The pressure unit 132 includes two rollers 1321 and 1322 and the pressure belt 1323 suspended between the rollers 1321 and 1322. The pressure unit 132 is configured such that a tensed belt surface of the surface of the pressure belt 1323 tensed by the two rollers 1321 and 1322 is pressured to a peripheral surface of the pressure roller 131, and so the nip portion formed by the heating roller 131 and the pressure belt 1323 becomes wider. A sheet which has been subjected to fixing processing is transported to a sheet discharge tray 4 disposed in an upper portion of the housing body 3.

In this apparatus, a cleaner unit 71 is disposed to face the blade facing roller 83. The cleaner unit 71 includes a cleaner blade 711 and a waste toner box 713. A front end of the cleaner blade 711 comes into contact with the blade facing roller 83 through the transfer belt 81 to remove foreign substances such as toners or paper particles remaining on the transfer belt 81 after secondary transfer. The removed foreign substances are collected by the waste toner box 713.

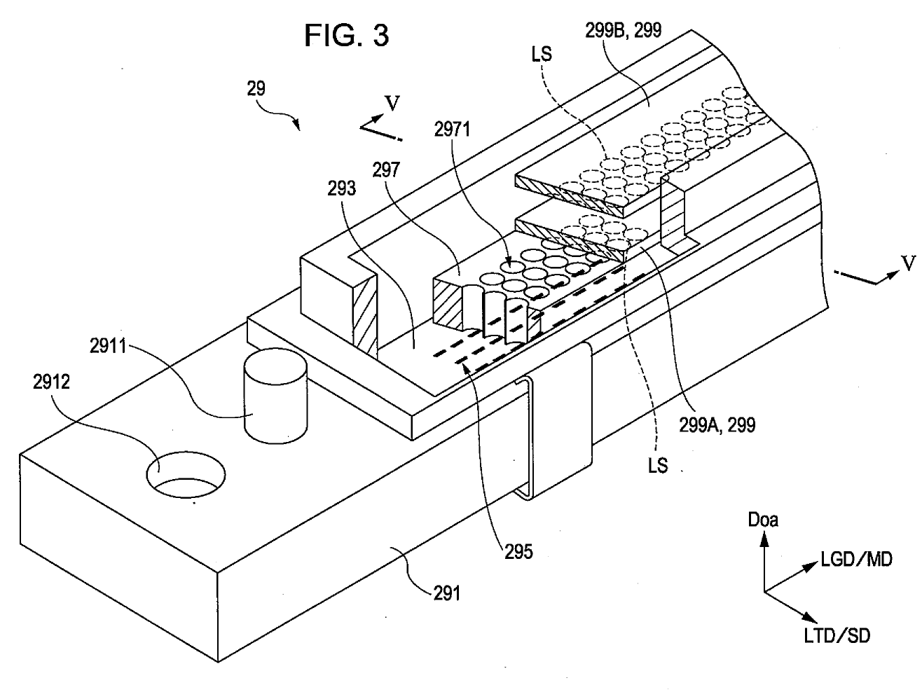

FIG. 3 is a schematic perspective view of the line head. Line of FIG. 3 is parallel to a direction Da-a which will be described later. As described above, the longitudinal direction LGD of the line head 29 is parallel or nearly parallel to the main scanning direction MD, and the width direction LTD of the line head 29 is parallel or nearly parallel to the sub scanning direction SD. The longitudinal direction LGD and the width direction LTD of the line head 29 are perpendicular or nearly perpendicular to each other. Each light emitting element of the line head 29 emits an optical beam toward the surface of the photoreceptor drum 21. In this specification, a direction which is perpendicular or nearly perpendicular to the longitudinal direction LGD and the width direction LTD and faces the surface of the photoreceptor drum 21 from the light emitting element is referred to as an advancing direction Doa of the optical beam. The advancing direction Doa of the optical beam is parallel or nearly parallel to an optical axis OA of an image optical system which will be described later.

A positioning pin 2911 and a screw hole 2912 are disposed on both ends of the longitudinal direction LGD of a case 291 of the line head 29. The positioning pin 2911 is inserted into a positioning hole (not illustrated) of a photoreceptor cover (not illustrated) positioned to the photoreceptor drum 21 to position the line head 29 to the photoreceptor drum 21. A fixing screw inserted into the screw hole 2912 is inserted into a screw hole (not illustrated) of the photoreceptor cover to fix the line head 29 to the photoreceptor drum 21.

In the inside of the case 291, a head substrate 293, a light shielding member 297, and two lens arrays 299 (299A and 299B) are disposed in this order in the advancing direction Doa of the optical beam. Light emitting element groups 295 respectively include a plurality of light emitting elements which are grouped and are two-dimensionally discretely disposed on a back surface of the head substrate 293. The head substrate 293 has two surfaces which are lined up in parallel to each other in the advancing direction Doa of the optical beam. In this specification, a head substrate surface at an upstream side of the advancing direction Doa of the optical beam is referred to as a “back surface of the head substrate 293”, and a head substrate surface at a downstream side of the advancing direction Doa of the optical beam is referred to as a “surface of the head substrate 293”.

In each of the lens arrays 299A and 299B, a plurality of lenses LS faces the plurality of light emitting groups 295 in a one-to-one correspondence relationship. In each lens array 299, the plurality of lenses LS is two-dimensionally disposed. Light guide holes 2971 which penetrate the light shielding member 297 in the advancing direction Doa of the optical beam are disposed in the light shielding member 297 disposed between the lens array 299 and the head substrate 293. The light guide hole 2971 is disposed for each element of the light emitting element groups 295. Therefore, the light emitting element groups 295 emit the optical beam to be directed to the corresponding lens LS through the light guide hole 2971. The two lenses LS and LS image the optical beam on the surface of the photoreceptor drum 21 as a spot. The light shielding member 297 inhibits a crosstalk that light emitted from the light emitting element groups 295 is incident to a lens LS which does not correspond to the corresponding light emitting element groups 295.

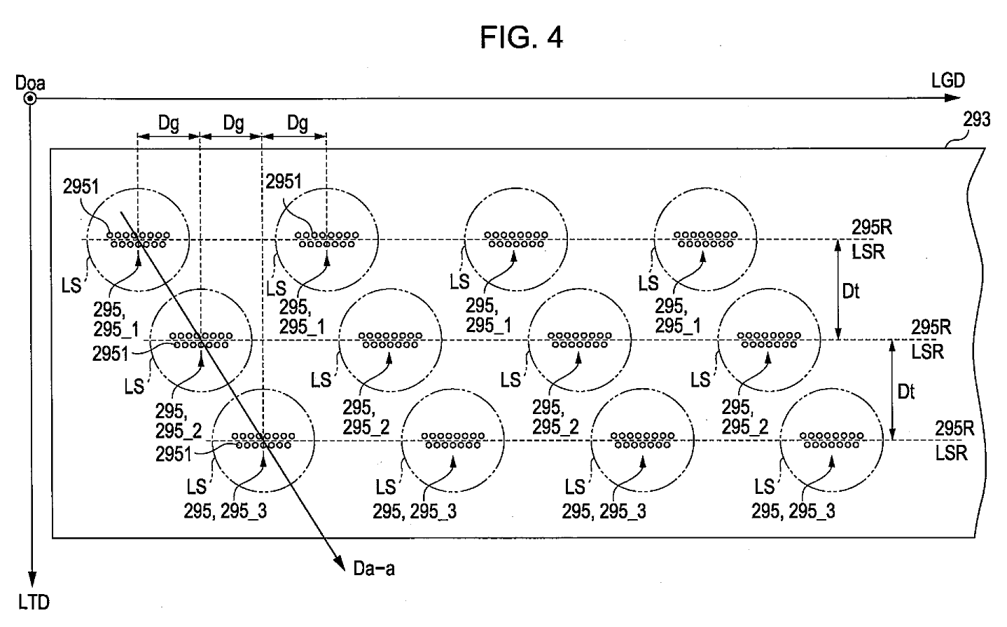

FIG. 4 is a plan view illustrating a configuration of the back surface of the head substrate when the back surface is seen from the surface side of the head substrate 293. In FIG. 4, the lens LS is indicated by a two-point chain line. This is to represent a correspondence relationship between the light emitting element groups 295 and the lens LS, but it does not mean that the lens LS is formed on the head substrate 293. A detailed configuration and arrangement of the light emitting element group 295 will be described below with reference to FIG. 4.

As illustrated in FIG. 4, each of the plurality of light emitting element groups 295 includes 15 light emitting elements 2951 which are lined up in two lines in zigzag manner in the longitudinal direction LGD. The plurality of light emitting element groups 295 is lined up in a straight line form at an interval three times that of an interval Dg in the longitudinal direction LGD to configure a light emitting element row 295R. On the other hand, in the lens array 299, the plurality of lens LS is lined up in a straight line form at an interval of an interval Dg×3 in the longitudinal direction LGD to configure a lens row LSR. The three light emitting element group rows 295R are disposed at an interval Dt in the width direction LTD. On the other hand, in the lens array 299, the three lens rows LSR are disposed at an interval Dt in the width direction LTD. The respective light emitting element group rows 295R are disposed to be shifted from each other by an interval Dg in the longitudinal direction LGD. Therefore, the respective light emitting groups 295 are disposed at different positions from each other in the longitudinal direction LGD. On the other hand, in the lens array 299, the respective lenses LS are disposed at different positions from each other in the longitudinal direction LGD. The three light emitting groups 295 (and the three lenses LS) are disposed to be lined up in a straight line form in the direction Da-a. A position of the light emitting group 295 may be obtained as a gravity center of the light emitting group 295 in the case of a front view from the advancing direction Doa of light. A position of the lens LS may be obtained as a position of the top of the lens LS in the case of a front view from the advancing direction Doa of light.

The line head 29 forms a latent image on the surface of the photoreceptor drum 21 similarly to an exposure operation disclosed in FIG. 11 of JP-A No. 2008-036937. That is, at timing based on movement of the surface of the photoreceptor drum 21 in the sub scanning direction SD, the respective light emitting elements 2951 emit light to form a plurality of spots lined up in the main scanning direction MD.

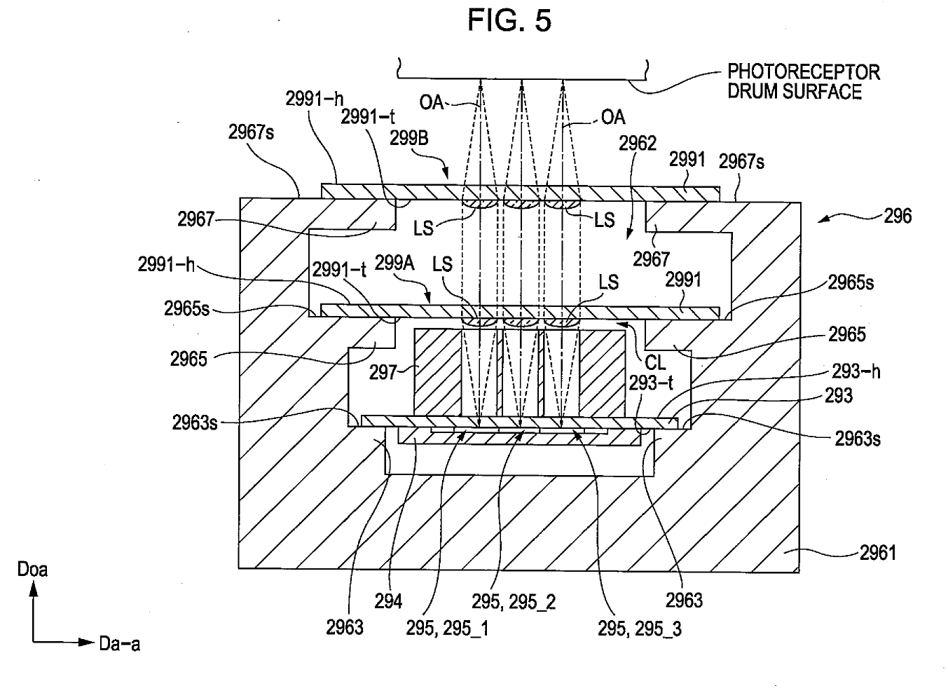

FIG. 5 is a partial cross-sectional view of the line head taken along line V-V according to the present embodiment. A detailed cross-sectional structure of the line head 29 will be described below with reference to FIG. 5. The light emitting element group 295 is formed on a back surface 293-t of the head substrate 293. Light emitting elements which configure the light emitting element groups 295 are a bottom-emission type organic electro-luminescence (EL) element and are covered with a sealing member 294. A bottom surface of the light shielding member 297 comes into contact with a surface 293-h of the head substrate 293. The head substrate 293 is a light transmissive substrate made of glass as a base material, and optical beams emitted from the respective light emitting elements of the light emitting element groups 295 transmit the head substrate 293 and are directed in an upward direction of FIG. 5 (the advancing direction Doa of the optical beam).

A first lens array 299A is disposed above the light shielding member 297 with a gap CL from the light shielding member 297. A second lens array 299B is disposed above the first lens array 299A. Each of the lens arrays 299A and 299B is configured such that the lenses LS are formed on the back surface 2991-t of the lens array substrate 2991. In particular, the lens array substrate 2991 is a light transmissive substrate made of glass as a base material, and the lenses LS made of resin are formed on the lens array substrate 2991. The lens arrays 299A and 299B may be formed by well-known techniques. For example, the lens arrays 299A and 299B may be formed by a method using a metallic mold. In this method, in a state in which a metallic mold having a concave portion corresponding to a shape of the lens LS comes into contact with the back surface 2991-t of the lens array substrate 2991, light curing resin is filled between the metallic mold and the lens array substrate 2991. When light is irradiated to the light curing resin, the resin is cured to form the lens LS on the lens array substrate 2991. The lens LS is not formed on the surface 2991-h of the lens array substrate 2991. Therefore, the lens arrays 299A and 2993 are configured such that plano-convex lenses which are convex toward the light emitting element groups 295 side are lined up.

The two lenses LS and LS disposed for each of the respective light emitting element groups 295 function as one image optical system. That is, an optical beam emitted from the light emitting element groups 295 forms an image (a dotted line in FIG. 5) on the surface of the photoreceptor drum 21 by the lenses LS and LS. In FIG. 5, the optical axis OA of the imaging optical system is denoted by a dash-dotted line.

In this embodiment, intervals of the head substrate 293 and the lens arrays 299A and 299B (the head substrate 293, etc.) in the advancing direction Doa of the optical beam are defined by a support member 296. The support member 296 includes a support member body 2961. In the inside of the support member body 2961, an arrangement space 2962 in which the head substrate 293, etc. is disposed is formed. The support member body 2961 has support protrusions 2963, 2965, and 2967 which are formed toward an inner side of the arrangement space 2962.

The head substrate support protrusion 2963 is formed to have a step shape and supports the back surface 293-t of the head substrate 293 through a top surface 2963s. The head substrate support protrusion 2963 has a length nearly equal to the head substrate 293 in the longitudinal direction LCD. The top surface 2963s of the head substrate support protrusion 2963 has a flat shape in a direction perpendicular or nearly perpendicular to the advancing direction Doa of the optical beam. The two head substrate support protrusions 2963 and 2963 are disposed on the left and right of FIG. 5 (that is, both sides of the head substrate 293 in the width direction LTD). The respective top surfaces 2963s and 2963s of the head substrate support protrusions 2963 and 2963 are at the same position (that is, at the same height as each other) as each other in the advancing direction Doa of the optical beam. The head substrate 293 is disposed to be stretched between the top surfaces 2963s and 2963s of the head substrate support protrusions 2963 and 2963. Therefore, the back surface 293-t of the head substrate 293 is supported by the support member 296 in a state which is perpendicular or nearly perpendicular to the advancing direction Doa of the optical beam. In the present embodiment, the two head substrate support protrusions 2963 function as a “second support portion” of the invention. The head substrate back surface 293-t and the head substrate support protrusion top surface 2963s may be fixed to each other by an adhesive agent in a state coming into contact with each other.

A first lens array support protrusion 2965 is disposed above the head substrate support protrusion 2963. The first lens array support protrusion 2965 is formed to protrude in an inner side direction of the arrangement space 2962, and supports the back surface 2991-t of the lens array substrate 2991 of the first lens array 299A through a top surface 2965s thereof. The first lens array support protrusion 2965 has the same length as the lens array substrate 2991 in the longitudinal direction LGD. The top surface 2965s of the first lens array support protrusion 2965 has a flat shape in a direction perpendicular or nearly perpendicular to the advancing direction Doa of the optical beam. The two first lens array support protrusions 2965 and 2965 are disposed on the left and right of FIG. 5 (that is, both sides of the first lens array 299A in the width direction LTD). The respective top surfaces 2965s and 2965s of the first lens array support protrusions 2965 and 2965 are at the same position (that is, at the same height as each other) as each other in the advancing direction Doa of the optical beam. The lens array substrate 2991 of the first lens array 299A is disposed to be stretched between the top surfaces 2965s and 2965s of the first lens array support protrusions 2965 and 2965. Therefore, the back surface 2991-t of the lens array substrate 2991 of the first lens array 299A is supported by the support member 296 in a state which is perpendicular or nearly perpendicular to the advancing direction Doa of the optical beam. In the present embodiment, the two first lens array support protrusions 2965 and 2965 function as a “first support portion” of the invention. The lens array substrate back surface 2991-t and the first lens array support protrusion top surface 2965s may be fixed to each other by an adhesive agent in a state coming into contact with each other.

A second lens array support protrusion 2967 is disposed above the first lens array support protrusion 2965. The second lens array support protrusion 2967 is formed to protrude in an inner side direction of the arrangement space 2962, and supports the back surface 2991-t of the lens array substrate 2991 of the second lens array 299B through a top surface 2967s thereof. The second lens array support protrusion 2967 has the same length as the lens array substrate 2991 in the longitudinal direction LGD. The top surface 2967s of the second lens array support protrusion 2967 has a flat shape in a direction perpendicular or nearly perpendicular to the advancing direction Doa of the optical beam. The two second lens array support protrusions 2967 and 2967 are disposed on the left and right of FIG. 5 (that is, both sides of the second lens array 299B in the width direction LTD). The respective top surfaces 2967s and 2967s of the second lens array support protrusions 2967 and 2967 are at the same position (that is, at the same height as each other) as each other in the advancing direction Doa of the optical beam. The lens array substrate 2991 of the second lens array 299B is disposed to be stretched between the top surfaces 2967s and 2967s of the second lens array support protrusions 2967 and 2967. Therefore, the back surface 2991-t of the lens array substrate 2991 of the second lens array 299B is supported by the support member 296 in a state which is perpendicular or nearly perpendicular to the advancing direction Doa of the optical beam. In the present embodiment, the two second lens array support protrusions 2967 and 2967 function as a “first support portion” of the invention. The lens array substrate back surface 2991-t and the second lens array support protrusion top surface 2967s may be fixed to each other by an adhesive agent in a state coming into contact with each other.

Therefore, the head substrate back surface 293-t, the lens array substrate back surface 2991-t of the first lens array 299A, and the lens array substrate back surface 2991-t of the second lens array 299B are parallel or nearly parallel to each other. The respective support protrusions 2963, 2965, and 2967 are connected through the support member body 2961, and the respective support protrusions 2963, 2965, and 2967 are positioned by the support member body 2961. The respective support protrusions 2963, 2965, and 2967 and the support member body 2961 are integrally formed.

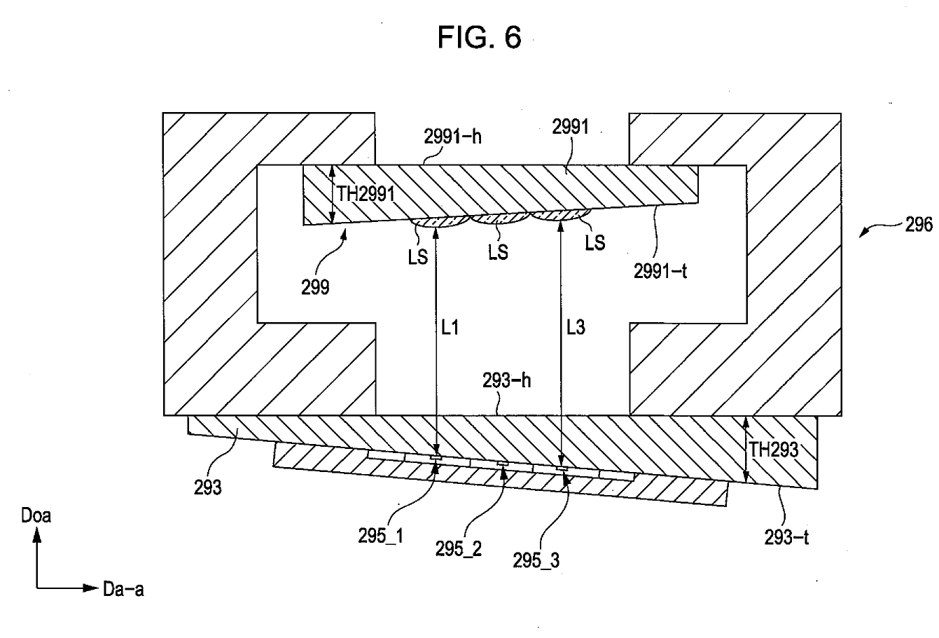

In the present embodiment, the lens LS forming surface of the lens array substrate 2991 (that is, the lens array substrate back surface 2991-t) and the light emitting element forming surface of the head substrate 293 (that is, the head substrate back surface 293-t) are supported by the support member 296. Therefore, a distance between the lens LS forming surface of the lens array substrate 2991 and the light emitting element forming surface of the head substrate 293 can be defined regardless of the thickness of the glass substrates 2991 and 293 (the light transmissive substrate). As a result, a distance between the lens LS and the light emitting element (the light emitting element groups 295) can be defined with high accuracy, whereby excellent exposure can be achieved. This will be described with reference to FIGS. 6 to 8. In the present embodiment, the two lens arrays 299A and 299B are used, but the effect of the invention in which a distance between the lens LS and the light emitting element group 295 can be defined regardless of the thickness of the glass substrates 2991 and 293 (the light transmissive substrate) can be equally obtained even when one of the two lens arrays 299A and 299B is used. Therefore, in FIGS. 6 to 8, the effect of the invention will be described using one lens array 299.

FIG. 6 is a partial cross-sectional view for explaining a problem to be resolved by the invention. In FIG. 6, a surface of the lens array substrate 2991 on which the lens LS is not formed (that is, the lens array substrate surface 2991-h) and a surface of the head substrate 293 on which the light emitting element is not formed (that is, the head substrate surface 293-h) are supported by the support member 296. The thickness TH2991 of the lens array substrate 2991 is not uniform in the direction Da-a, and the thickness TH293 of the head substrate 293 is not uniform in the direction Da-a. As a result, a distance L1 between the light emitting element group 295_1 and the lens LS is shortened, and a distance L3 between the light emitting element group 295_3 and the lens LS becomes lengthy.

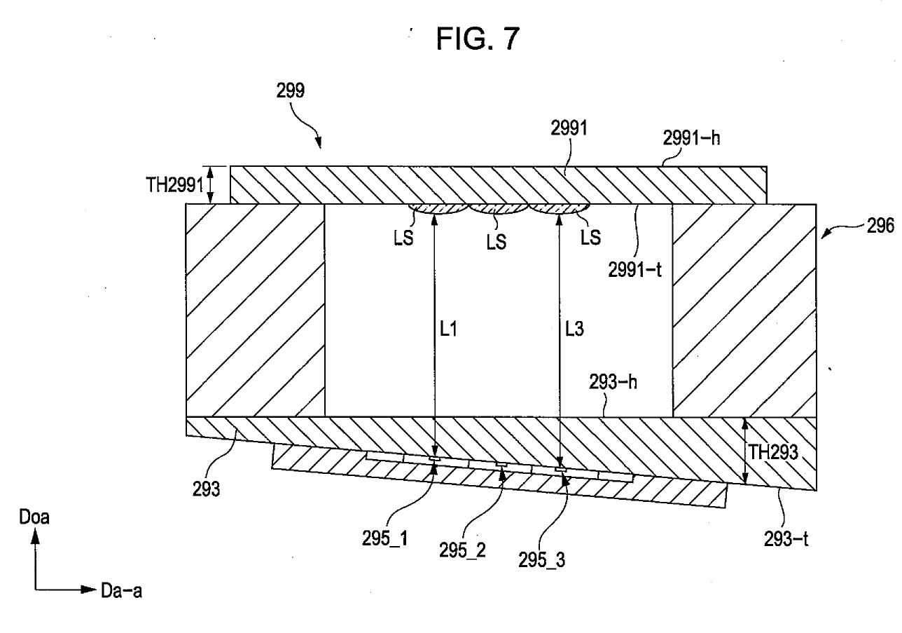

FIG. 7 is a partial cross-sectional view, for explaining a problem to be resolved by the invention. In FIG. 7, a surface of the lens array substrate 2991 on which the lens LS is formed (that is, the lens array substrate back surface 2991-t) is supported by the support member 296, and a surface of the head substrate 293 on which the light emitting element is not formed (that is, the head substrate surface 293-h) is supported by the support member 296. The thickness TH293 of the head substrate 293 is not uniform in the direction Da-a. As a result, a distance L1 between the light emitting element group 295_1 and the lens LS is shortened, and a distance L3 between the light emitting element group 295_3 and the lens LS becomes lengthy. In the configurations illustrated in FIGS. 6 and 7, since the thickness TH2991 and the thickness TH293 of the glass substrates (the lens array substrate and the head substrate) are not uniform, the distance between the light emitting element groups 295 (the light emitting element) and the lens LS varies.

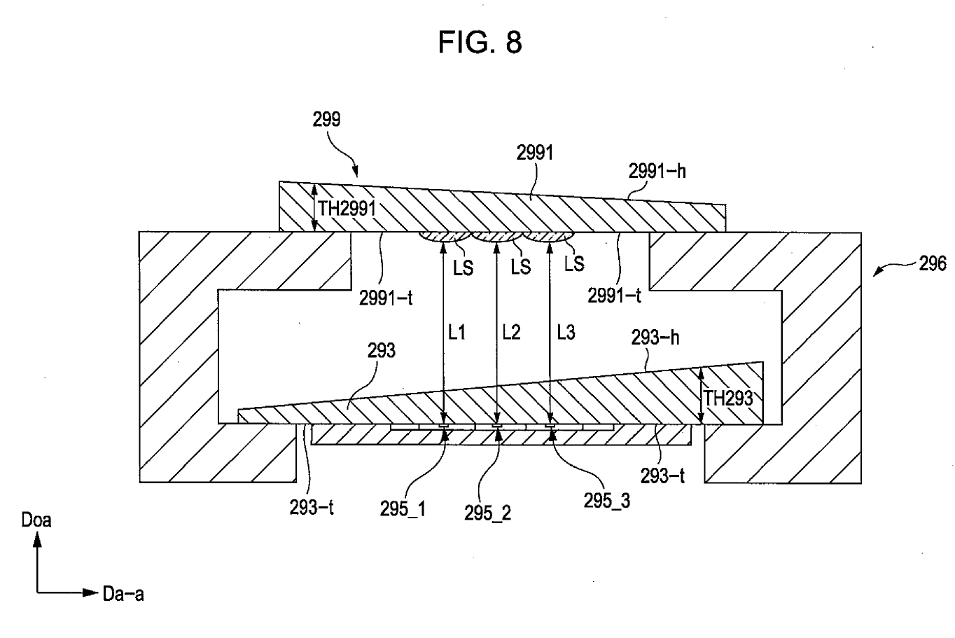

FIG. 8 is a partial cross-sectional view for explaining the effect of the invention. In FIG. 8, similarly to FIG. 6, the thickness TH2991 and the thickness TH293 of the glass substrates (the lens array substrate and the head substrate) are not uniform. However, in FIG. 8, the lens LS forming surface of the lens array substrate 2991 (that is, the lens array substrate back surface 2991-t) and the light emitting element forming surface of the head substrate 293 (that is, the head substrate back surface 293-t) are supported by the support member 296. As a result, the distances L1, L2, and L3 between the respective light emitting element groups 295_1, 295_2, and 295_3 and the lenses LS are the same. Therefore, the distance between the lens LS and the light emitting element groups 295 (the light emitting element) can be defined with high accuracy, whereby excellent exposure can be achieved.

In the present embodiment, the support member 296 has the support protrusions 2965 and 2965 (2967 and 2967) which support the lens array substrate back surface 2991-t, the support protrusions 2963 and 2963 which support the head substrate back surface 293-t, and the support member body 2961 (a connecting portion) which positions and connects the support protrusions 2963 and 2963 and 2965 and 2965 (2967 and 2967). As described above, since the support protrusions 2963 and 2963 and 2965 and 2965 (2967 and 2967) are positioned by the support member body 2961, the distance between the lens array substrate back surface 2991-t and the head substrate back surface 293-t can be accurately defined. As a result, the distance between the lens LS and the light emitting elements 2951 can be defined with high accuracy, whereby exposure of high accuracy can be achieved.

In the present embodiment, the respective support protrusions 2963 and 2963 and 2965 and 2965 (2967 and 2967) support the lens array substrate 2991 and the head substrate 293 so that the lens array substrate back surface 2991-t and the head substrate back surface 293-t can be parallel or nearly parallel to each other. As a result, the distance between the lens LS and the light emitting elements 2951 is defined with high accuracy, whereby excellent exposure can be achieved.

In the present embodiment, the respective support protrusions 2963 and 2963, 2965 and 2965, and 2967 and 2967 are preferably formed to be integrated with the support member body 2961. When the respective portions (the respective support protrusions 2963, 2965, and 2967, and the support member body 2961) are separately configured and then combined, a surplus gap may be formed between the respective portions. On the other hand, when the respective portions are integrally configured, the surplus gap is inhibited from being formed, and the distance between the lens array substrate back surface 2991-t and the head substrate 293-t can be more accurately defined.

In the configuration having the light shielding member 297, the distance defined by the support member 296 may be derailed due to contact between the light shielding member 297 and the lens array 299A. In order to prevent the problem, in the present embodiment, the gap CL is preferably present between the lens array 299A and the light shielding member 297.

In the present embodiment, the lens array substrate 2991 and the head substrate 293 are glass substrates made of glass as a base material. Since a material of a relatively low price such as glass is used as a base material, the cost of the line head 29 can be lower.

As described above, in the present embodiment, the line head 29 corresponds to an “exposure head” of the invention, the lens array substrate 2991 corresponds to a “first light transmissive substrate” of the invention, the head substrate 293 corresponds to a “second light transmissive substrate”, the two support protrusions 2965 and 2965 (2967 and 2967) correspond to a “first support portion” of the invention, and the two support protrusions 2963 and 2963 correspond to a “second support portion” of the invention.

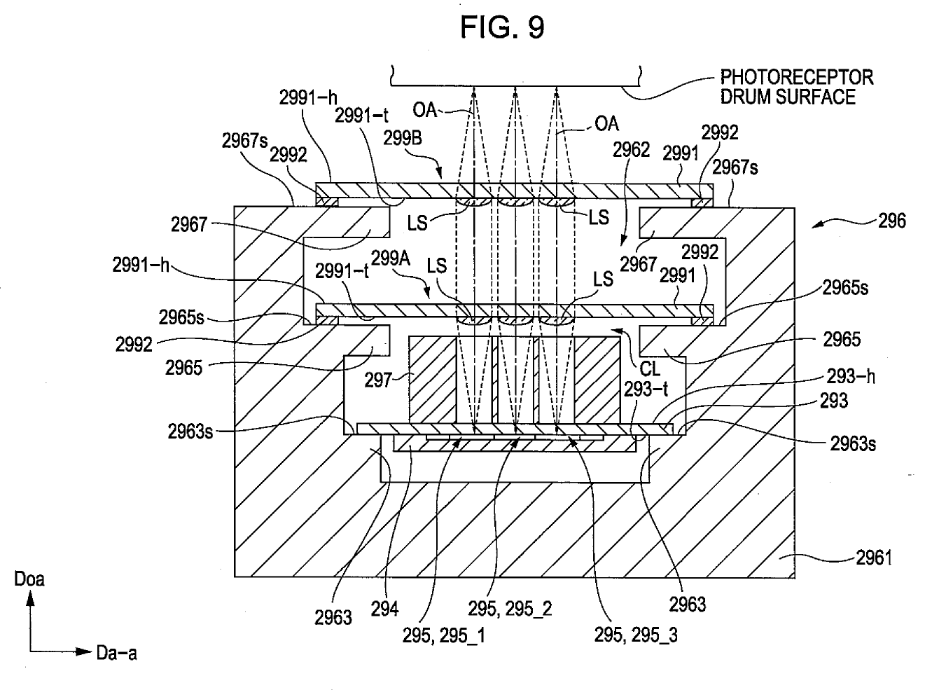

The invention is not limited to the embodiment described above, and various modifications can be made without departing from the spirit of the invention. For example, in the above-described embodiment, the lens array substrate 2991 and the head substrate 293 directly come into contact with and are supported by the support member 296. However, the lens array substrate 2991 and the head substrate 293 may be supported by the support member 296 through any other member (FIG. 9).

FIG. 9 is a partial cross-sectional view illustrating a modified embodiment. As illustrated in FIG. 9, seating surface protrusions 2992 with a predetermined height are disposed on both ends of the back surface 2991-t of the lens array substrate 2991 of a left-right direction of FIG. 9. The height of the seating surface protrusions is accurately defined in a manufacturing process. The lens LS forming surface of the lens array substrate 2991 (that is, the lens array substrate back surface 2991-t) is supported by the support member 296 through the seating surface protrusion 2992. As described above, even in the embodiment illustrated in FIG. 9, the lens LS forming surface of the lens array substrate 2991 (that is, the lens array substrate back surface 2991-t) and the light emitting element forming surface of the head substrate 293 (that is, the head substrate back surface 293-t) are supported by the support member 296. Therefore, the distance between the lens LS forming surface of the lens array substrate 2991 and the light emitting element forming surface of the head substrate 293 can be defined regardless of the thickness of the glass substrates 2991 and 293 (the light transmissive substrate). As a result, the distance between the lens LS and the light emitting element (the light emitting element group 295) can be defined with high accuracy, whereby excellent exposure can be achieved. Since the configurations of FIGS. 9 and 5 are identical to each other except the seating surface protrusion 2992, components of FIG. 9 which are the same as in FIG. 5 have the same reference numerals as in FIG. 5, and thus description of them is omitted.

In the above-described embodiment, the head substrate support protrusion 2963 is finished to have a step shape, and the first and second lens array support protrusions 2965 and 2967 may be finished to have a shape which protrudes toward the inner side of the arrangement space 2962. However, the shapes of the support protrusions 2963, 2965, and 2967 are not limited to the shapes described above.

In the above-described embodiment, the respective support protrusions 2963, 2965, and 2967 and the support member body 2961 are integrally formed. However, the respective support protrusions 2963, 2965, and 2967 and the support member body 2961 may be separately formed.

In the above-described embodiment, the respective lens arrays 299A and 2998 are configured such that the lenses LS are formed on the back surface 2991-t of the lens array substrate 2991. However, the respective lens arrays 299A and 299B may be configured such that the lenses LS are formed on the surface 2991-h of the lens array substrate 2991.

In the above-described embodiment, the two lens arrays 299A and 299B are used. However, the number of the lens arrays 299 is not limited to two and may be one, or three or more.

In the above-described embodiment, three lens rows LSR are present in each of the lens arrays 299A and 299B. However, the number of lens rows LSR in each of the lens arrays 299A and 299B is not limited to three.

In the above-described embodiment, the light emitting element groups 295 include the fifteen light emitting elements 2951. However, the number of the light emitting elements 2951 which configure the light emitting element groups 295 is not limited to fifteen.

The entire disclosure of Japanese Patent Applications No. 2008-304813, filed on Nov. 28, 2008 is expressly incorporated by reference herein.

What is claimed is:

1. An exposure head, comprising:
a lens array that has a first light transmissive substrate and a lens disposed on a first surface of the first light transmissive substrate;
a second light transmissive substrate;
a light emitting element that is disposed on a second surface of the second light transmissive substrate and emits light that transmitting the second light transmissive substrate to form an image through the lens; and
a support member that supports the first surface and the second surface.

2. The exposure head according to claim 1, wherein the support member supports the first surface is disposed in parallel or nearly parallel.

3. The exposure head according to claim 1, wherein the support member includes a first support portion that supports the first surface, a second support portion that supports the second surface, and a connecting portion that connects the first support portion and the second support portion.

4. The exposure head according to claim 3, wherein the first support portion, the second support portion, and the connecting portion are integrally formed.

5. The exposure head according to claim 1, further comprising, a light shielding member that is disposed between the second light transmissive substrate and the lens array and has a light guide hole that allows light from the light emitting element to transmit, and a gap is present between the lens array and the light shielding member.

6. The exposure head according to claim 1, wherein the first light transmissive substrate and the second light transmissive substrate are made of glass as a base material.

7. An image forming apparatus, comprising:
an exposure head that includes a lens array that has a first light transmissive substrate and a lens disposed on a first surface of the first light transmissive substrate, a second light transmissive substrate, a light emitting element that is disposed on a second surface of the second light transmissive substrate and emits light imaged by the lens, and a support member that supports the first surface and the second surface; and
a latent image carrier that is exposed to the imaged light by the exposure head.
